(19) United States
(12) Patent Application Publication
(10) Pub. No.: US 2018/0316509 A1
(43) Pub. Date: Nov. 1, 2018

(54) Method and System for Authentication of Electronic Documents

(71) Applicant: Agreement Express Inc., Vancouver (CA)

(72) Inventors: Michael Walter GARDNER, Vancouver (CA); Goran RADISAVLJEVIC, Vancouver (CA); Michael Joseph CHRISTIE, Port Coquitlam (CA)

(21) Appl. No.: 16/027,341

(22) Filed: Jul. 4, 2018

Related U.S. Application Data
(63) Continuation-in-part of application No. PCT/CA2017/050002, filed on Jan. 3, 2017.
(60) Provisional application No. 62/274,974, filed on Jan. 5, 2016.

(51) Int. Cl. H04L 9/32; G06F 21/64; G06F 21/40

(52) U.S. Cl. CPC H04L 9/3247; H04L 9/3263; G06F 21/40; G06F 21/64

(57) ABSTRACT

A method and system for electronic document execution, providing for enhanced authentication of the particular electronic document in an electronic contract management platform. A hybrid electronic signature system, wherein a party wishing to electronically execute an electronic document can apply to the electronic document, in electronic form, a digitized graphical representation of his physical signature (in a scalable vector graphics (SVG) format)), and also embed a digital certificate (an X509 digital certificate) of the executing party into the electronic document. The hybrid signature method can incorporate multifactor authentication of users, such that only appropriately authenticated users may be granted access to the platform and be permitted to electronically sign the electronic documents, thereby providing for enhanced security.

### CROSS-REFERENCE TO RELATED APPLICATION(S)

This application is a continuation of PCT Application No. PCT/CA2017/050002 filed on Jan. 3, 2017, which claims priority to U.S. Provisional Patent Application No. 62/274,974 filed on Jan. 5, 2016, both incorporated herein by reference.

### TECHNICAL FIELD

The following relates to authenticating electronic documents, particularly in applying electronic signatures to such electronic documents.

### DESCRIPTION OF THE RELATED ART

The use of electronic documents, and specifically electronic contracts, is well established. Various methods are available to enable or facilitate contracting parties to sign/execute such electronic contracts.

When a person physically signs a paper document (with a so-called “wet” signature) for example, anyone who recognises that person's signature knows (or at least is reasonably confident) that that person assented to the contents of that document. Similarly, when a person digitally or electronically signs an electronic document, anyone who “recognises” that electronic signature knows (or at least is reasonably confident) that the signature came from that person. The process of “recognising” electronic signatures is often referred to as verification.

An important consideration regarding execution of electronic contracts relates to the authenticity of the applied signature or signatures. It can be advantageous to be able to verify that a contract has indeed been executed by one or more of the parties purporting to have executed it. This may, for example, reduce the risk of fraud or forgery. Such a verification step can be applied in any of a number of different scenarios. For example, this might be applied where a third party wishes to verify electronically executed electronic contracts for auditing purposes. This may for example also be applied during the contracting process itself, where a party to an agreement can seek to verify that an electronically signed contract was indeed properly executed by the identified executing party. The foregoing is all the more relevant given that commercial agreements these days are often executed with the executing parties in different locations (rather than in the physical presence of each other), and where the executing parties do not know each other well (e.g. parties involved in online commercial transactions).

Certain measures to enable or facilitate the verification of an electronic signature as applied to an electronic contract are known. In one aspect, whenever an executing party to an electronic contract electronically executes such a contract, a digital certificate may be embedded within the electronic document. The digital certificate is generally unique, secure and generally known only to the executing party. Any other party (or an auditor, for example) can cross-check the digital certificate(s)(i.e., since the identity of the executing party or parties associated with a particular digital certificate may be maintained by a third party).

One limitation with the use of such digital certificates in electronic signature systems is that most users are generally more familiar and comfortable dealing with traditional, “wet” signatures. Users would tend to be more comfortable with seeing a written signature or something that looks like a written signature. Accordingly, it is contemplated that it would be advantageous to provide for an improved, secure method for electronically signing an electronic contract, wherein the electronic signature may be authenticated, and where a graphical representation of the executing party's actual signature can be applied to the electronic contract and viewed by other users.

### SUMMARY

Disclosed herein is a system and method by means of which the execution of electronic contracts and other documents may be facilitated, which among other things provides for enhanced authenticity and non-repudiation of such electronic contracts and documents.

In one aspect, there is provided a method of authenticating electronic documents, the method comprising: enabling a first signing entity to connect to a server system, the server system having an electronic document securely uploaded thereto for signing by one or more signing entities including the first signing entity; authenticating the first signing entity with the server system using at least one authentication operation; obtaining a first graphical representation of a physical signature for the first signing entity; applying a hybrid signature to the electronic document to generate an electronically signed document, the hybrid signature comprising the graphical representation of the physical signature and a first cryptographic element associated with the first signing entity; outputting the electronically signed document or a link thereto; and storing the electronically signed document with the server system.

In other aspects, there are provided computer readable media and systems configured to perform the method.

### BRIEF DESCRIPTION OF THE DRAWINGS

Embodiments of the present invention are described below with reference to the accompanying drawings in which:

FIG. 1 is a graphical representation illustrating the process flow of an embodiment of the present invention.

FIG. 2 is a diagram illustrating an embodiment of the present invention.

FIG. 3 is a diagram illustrating an embodiment of the present invention, specifically in the context of an electronic document (contract) management system.

FIG. 4 is a diagram illustrating the process flow for a simple authentication method.

FIG. 5 is a diagram illustrating the process flow of a two factor authentication method in accordance with an aspect of the present invention.

FIG. 6 is a diagram illustrating the process flow of a two-step authentication method in accordance with an aspect of the present invention.

### DETAILED DESCRIPTION

The following is described more fully with reference to the accompanying drawings, in which one or more illustrative embodiments are shown. The system and method described herein may, however, be embodied in many different forms and should not be construed as limited to the embodiments set forth herein; rather, these embodiments are provided so that this disclosure will be thorough and complete, and will fully convey the scope of what is outlined in the appended claims. Among other things, the principles discussed herein may be embodied as methods, systems or devices. The following descriptions are presented for illustrative purposes only, and should not be taken in a limiting sense.

Although the present disclosure discusses signatures in the context of execution of contracts, it is to be understood that the present invention may be applied in any similar situation in which a party may traditionally affix his signature or in which a party may wish to evidence his agreement to or approval of a document (or part of a document).

The system described herein is contemplated and more particularly described in the context of a document signing platform, and more specifically of an electronic contract management platform. Within such an electronic contract management platform, the authenticity of the signatures (or such other applicable form of execution) is, as previously mentioned, very important. The following is generally discussed in terms of electronic contracts that are produced and saved as Portable Document Format (PDF) documents. This is one preferred electronic document format for the application of the system described herein, and is commercially the most common and suitable document format used for handling electronic contracts. However, it should be understood that the principles described herein may be applied in similar fashion to documents in other formats.

Disclosed herein is a method and system for electronic document execution, providing for enhanced authentication of the particular electronic document. Disclosed herein is a hybrid electronic signature system, wherein a party wishing to electronically execute an electronic document can apply to the electronic document, in electronic form, a digitized graphical representation of his/her physical signature (in a preferred embodiment, this is provided in a scalable vector graphics (SVG) format), and also embed a digital certificate (in a preferred embodiment, this would be an X509 digital certificate) for the executing party into the electronic document.

In accordance with another aspect, the digitized, graphical representation of the executing party's physical signature is captured from the user's electronic device (which may be a smartphone, tablet, mobile communication device, desktop or laptop computer, personal digital assistant, smart watch, etc.), and stored for future use, as and when it is required. In one embodiment, the signature may be saved in SVG format on the servers of a document signing platform.

In accordance with another aspect, a system providing the hybrid signature described herein can additionally provide for single and/or multi-factor and/or single/multi-step authentication of users, such that only appropriately authenticated users may be granted access to the platform and can execute electronic documents, thereby providing for enhanced security measures.

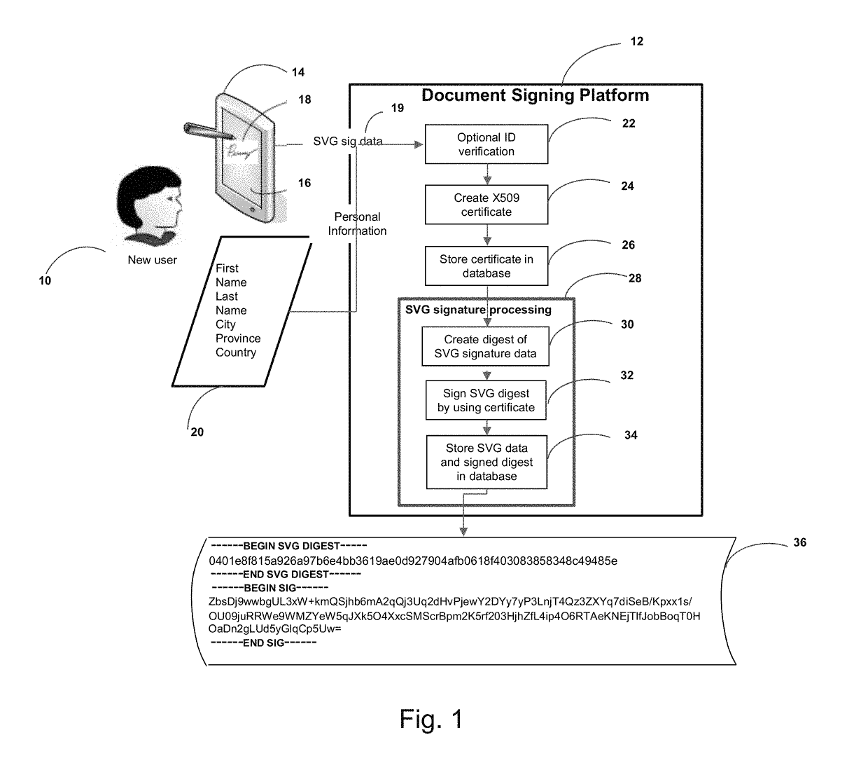

Referring to FIG. 1, a schematic illustration of the process flow for an exemplary embodiment is provided. A new user 10 wishing to utilise the hybrid electronic signature system accesses a document signing platform 12 via his/her electronic device 14 (e.g. via the Internet or such other communication network). As illustrated, the electronic device 14 can be portable electronic device such as a smartphone. Access to the platform 12 may be provided via a browser on the electronic device 14 or via a software application running on the electronic device (for ease of illustration, not specifically shown). Generally, the browser/software application provides a user interface, which can include a graphical user interface, through which the user can interact with the platform 12.

In the case of a first time user, the user 10 is prompted to provide various personal information or identification information, such as the user's name, geographical location, etc. (step 20). The user 10 can provide a sample of his/her signature by “writing” (e.g. using touch or using a stylus, as appropriate for the electronic device) his/her signature 18 via the graphical user interface 16 on his electronic device 14. This user's signature is digitally captured (digitized) and provided to the platform 12 in this example in the form of SVG signature data 19. SVG is an XML-based vector image format for two-dimensional graphics with support for interactivity and animation. While the examples herein refer to an SVG format for the signature data 19, it can be appreciated that the graphical representation of a signature can be stored in any suitable format, for example, png, jpg, bmp, etc. Such formats can also have hashes, signing using certificates applied in a manner similar to that described herein. Optionally, the platform 12 may request the user 10 to provide other identification information for verification purposes (step 22). A digital public key certificate (such as one conforming to the X.509 standard) is created for this specific user 10 (step 24). The X.509 certificate is stored on a database on the platform (step 26).

The user's SVG signature is then processed in a SVG signature processing stage (28). A digest is created for the SVG signature data 19 (step 30). The user's X.509 certificate is applied to (or “signed” on) the created SVG digest (step 32). The “signed” digest, as well as the SVG signature data 19 is stored in a database on the platform 12 (step 34). Cryptographic hash functions (used to create a so called digest or hash) are mathematical operations performed on digital data; by comparing the computed “hash” (the output from execution of the algorithm) to a known and expected hash value, a person can determine the data's integrity. For example, computing the hash of a downloaded file and comparing the result to a previously published hash result can show whether the download has been modified or tampered with. A key aspect of cryptographic hash functions is their collision resistance: i.e. one should not be able to find two different input values that result in the same hash output. Since the created digest/hash can be represented as text, it can be digitally signed like any other message, to provide an additional level of tamper resistance. An example of the hash output is shown in step 36.

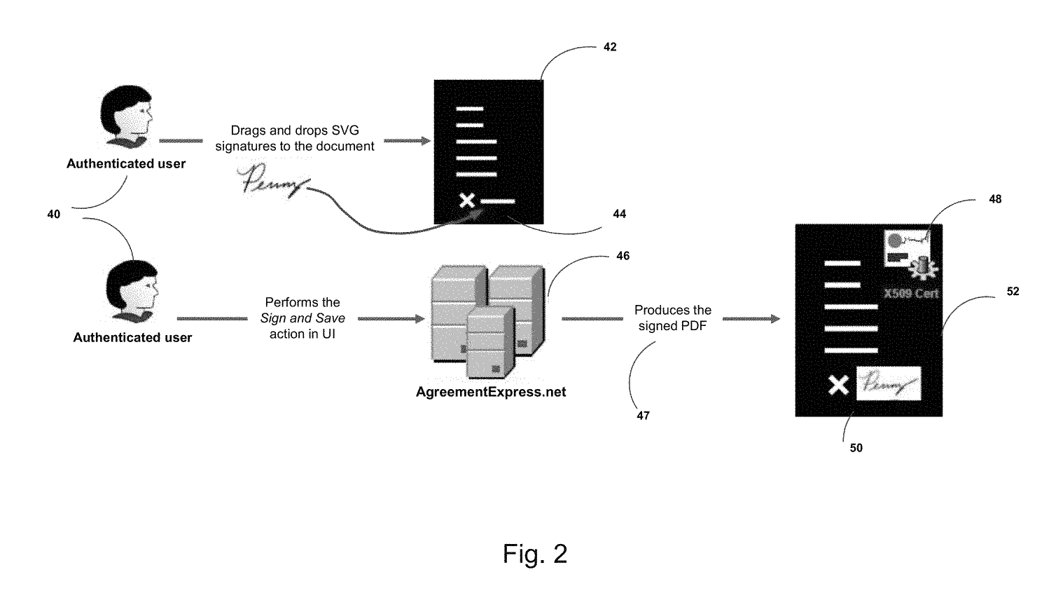

FIG. 2 is a diagram schematically illustrating a scenario in the case of a user who has already been authenticated as described in the process discussed above (referred to as an authenticated user 40), and who is thus “recognised” by the platform. The authenticated user 40 is presented with an electronic document or contract 42 (typically in the form of a PDF document) within the document signing platform 12. The authenticated user 40 can view and review the electronic contract 42. When the authenticated user 40 wishes to sign the electronic contract 42, he/she can, via the user interface 16 on his/her electronic device 14, indicate his/her intention to do so and can “drag and drop” his/her SVG signature 44 (which was stored on the platform 12) into the appropriate location of the electronic document 42. In alternative iterations, it may not be necessary for the user 40 to “drag and drop” his signature into a suitable location on the electronic document; the electronic document may specify the precise appropriate location for SVG signatures to go, in which case, the user simply needs to “click to sign” in order for the SVG to automatically be applied to the appropriate location on the electronic document 42. Once the document is “signed” (with the SVG signature), it is then saved to the platform for processing (step 46). Optionally, the user may be prompted to confirm he is satisfied with the signing action before saving; or the user may be provided with a simple “sign and save” option. It can be appreciated that while the platform 12 preferably securely stores the SVG signature for authenticated or enrolled users, the platform 12 may also be configured to authenticate the signing entity (i.e. the user) and have the user provide a fresh signature or one stored on an enrolled (authenticated and/or approved) device for that user, with a history of users' signatures maintained by the system.

The document which the user has electronically “signed” is then further processed (step 47) to append or otherwise incorporate a cryptographic element such as a digital certificate (e.g. X.509 certificates commonly used for PDFs). In the example shown, an X.509 certificate 48 associated with the authenticated user 40 is applied to the electronic document and electronically embedded therein. In addition, the SVG signature 44 of the authenticated user 40 is also applied to the electronic document. Visually, the electronic document when viewed will have a digitized version of the user's signature, with a transparent background. This “signed” document 48 (which in the preferred embodiment is a flattened PDF version of the previous document) is then saved on the platform 12.

A similar process may be utilised in the case of documents/contracts requiring signatures from multiple parties. Typically, the final version of a fully executed electronic contract will have X.509 certificates from each signing party embedded within the electronic contract, as well as digitized SVG signatures of each signing party (with SVG signatures being visible). That is for each signer, the digitally signed document that is stored by the platform 12 includes a cryptographic element associated with that signer, as well as that signer's graphical representation of their physical signature.

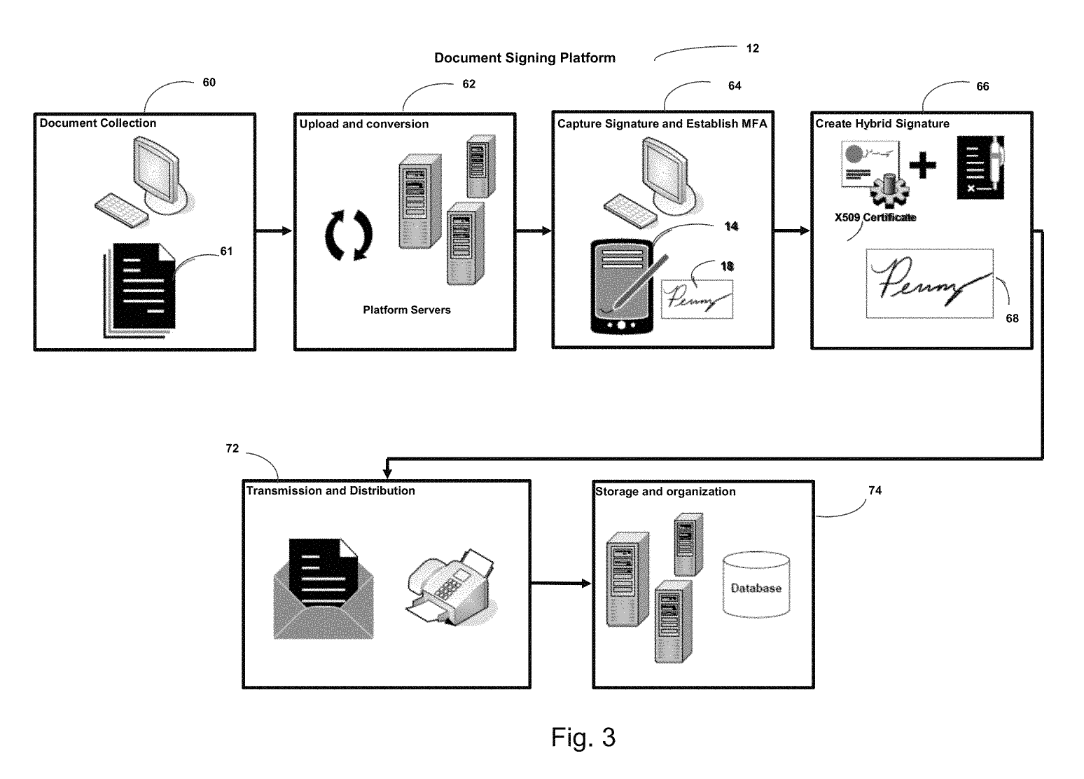

FIG. 3 is a diagram illustrating an embodiment specifically in the context of an electronic document (contract) signing platform 12. The platform 12 provides for documents 61 to be collected in electronic format (step 60). The documents may be securely uploaded to the platform servers and converted into a proprietary format (step 62). For example, Word™ documents, Excel™ spreadsheets or images may be converted into PDF or HTML format. Users wishing to utilise the electronic signature functionality to sign electronic documents login to access the platform (step 64). For example, returning users can enter their password to activate the image of their signature and tap to apply the signature. New users can be sent a text message to create a multi-factor authentication as discussed below, and use their electronic device (e.g., smart phone) as a signature capture device. Returning uses on a new device can also be made to enter a security code sent to their mobile device. In this way, the platform 12 provides an element of security and control to the document (e.g. contract) signing process. By controlling not only the capturing (and potentially storing) of graphical representations of physical signatures, as well as authenticating the users that are meant to be signing the documents, enhanced authentication and security measures are provided for potentially sensitive and important operations such as contract execution.

Several single- or multi-factor and/or single- or multi-step authentication measures (as described in greater detail below) can be adopted in order to establish the identity of users, thereby providing for the above-mentioned enhanced security. In the case of a new user, upon setting up a user name and password, some form of multi-factor authentication step can also be utilised. For example, the user may be sent an electronic SMS (short message service) text message to their designated electronic device or smartphone 14 (also referred to herein as an enrolled electronic device) containing a security code, which security code must be entered in order to access the platform. The electronic device 14 can also be used to capture the new user's signature 18 and have it stored on the platform 12. In the case of a returning user, if that user logs in to the platform 12 using an electronic device that is recognized by the platform 12, then the user simply has to provide a username and password to gain access. If however, the returning user logs in to the platform using a new or unrecognized electronic device, the user can also be asked to enter a security code sent to their electronic device 14. Once the user is granted access to the platform, they will be able to activate the image of their SVG signature, and click/tap to apply the hybrid signature to a particular electronic document (step 66). As described previously, in one example, the hybrid signature comprises a SVG signature 68 and an embedded X.509 certificate (sometimes referred to herein as a “hybrid electronic signature”). As such, a flattened PDF version of a document would contain embedded X.509 certificates for all signers. The SVG signature may be saved using Base64 String SVG format to enrich the X.509 certificate. The document would visually have the digitalized version of persons signature/initials (Base64 string SVG) with a transparent background in the example shown in FIG. 3.

Once the hybrid signature is applied to an electronic document, the “signed” version of the document is saved on the platform 12. Additional functionality may be provided by the platform to facilitate further handling and management of the “signed” document. By way of example, the user may be given the option to send the signed document as an email link (so it can then be signed by other parties to the contract); as an email attachment (e.g. for saving/printing and for record keeping purposes); or by facsimile or other electronic mechanisms (step 72).

The fully signed/executed documents are then securely stored in a suitable document repository/database on the platform 12. The documents may be readily managed, organized and sorted (step 74), e.g. such that the documents can be organized based on sender, signer, or other metadata.

As a practical matter, when dealing PDF documents, adding a SVG signature (in the form of a graphic block) changes the electronic document. The coupling of SVG signatures and signing with an electronic certificate means that each signor technically signs a different document. Consequently, viewing the signature panel of a signed electronic document using Acrobat Reader™ will show that all certificate signatures other than the last one have “problems”; while this is understood, it is not really an issue, because all the versions of documents are tracked inside the PDF document.

There are a number of advantages with the hybrid electronic signature system described above. Firstly, various authentication measures such as single- and multi-factor authentication measures may be integrated with the system, in order to provide enhanced security. For example, only authenticated users may be permitted to access the system and electronically sign documents (examples of such authentication measures are described in greater detail below). Secondly, the use of the hybrid electronic signature facilitates automation. Further, the signing process may be performed remotely and electronically—no writing instrument (pen or pencil) is even required. The electronic signature process can readily be audited (i.e. electronic documents that are purported to have been signed by executing parties can be audited at any time by checking the digital certificates and/or the signature digests.

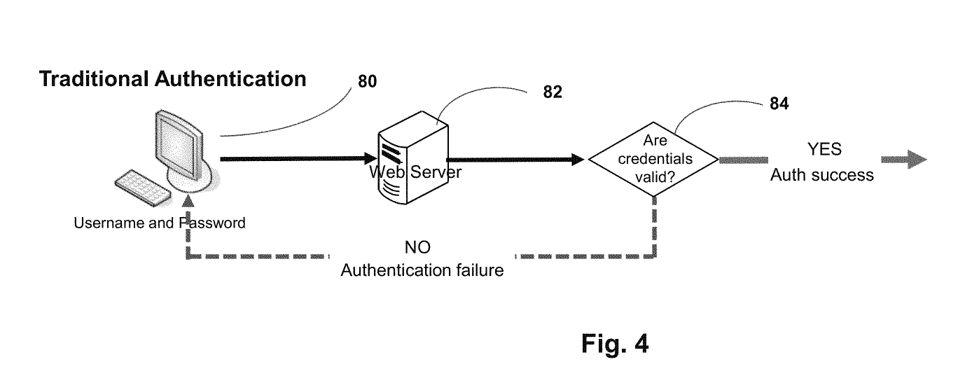

FIGS. 4-6 illustrate the process flow of some examples of the single- and multi-factor authentication measures mentioned above (as one part of step 64). FIG. 4 is a diagram illustrating the process flow for a simple traditional single-factor authentication method. In this case, a user seeking to log in to the system is simply asked to provide his/her username and password (step 80). If the credentials entered are valid (step 84), then the user is considered to have been authenticated and is granted access to the relevant system.

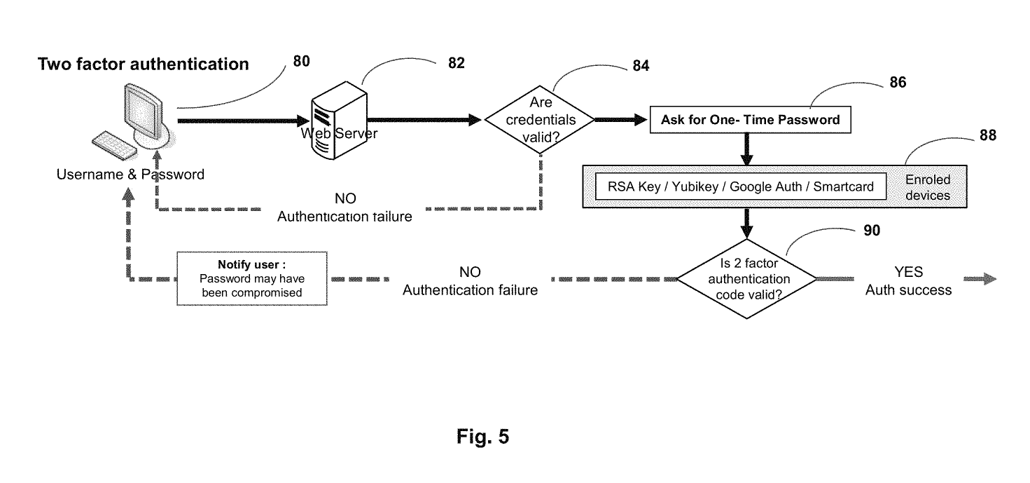

FIG. 5 is a diagram illustrating the process flow of a two factor authentication method. Two-factor authentication as used herein refers specifically and exclusively to authentication mechanisms where the two authentication elements fall under different categories with respect to:
(i) “something you know” (e.g. username and password)
(ii) “something you are” (e.g. biometric factors such as fingerprint, iris scan, facial recognition, etc.)
(iii) “something you have” (e.g. mobile phone, YubiKey™, RSA SecurID token)

Multi-factor authentication is considered to provide better security than single factor authentication, because an attacker has to perform two different types of theft in order to pose as the victim. For example, the adversary would need to compromise a computer to get the password and physically steal the token such as a YubiKey.

As described above, a user seeking to log in to the system is first asked to provide their username and password (step 80). If these credentials are valid, then the user is asked for a one-time password or security code (step 86), which may be sent to a device that the user has previously enrolled with the platform (i.e. an enrolled device)(step 88). This may take various forms, such as that using a RSA (Rivest Shamir Adleman public key cryptosystem) SecurID token key, YubiKey™, Google Authenticator™ application or smartcard, which are generally known security systems. If the one-time password or security code provided by the user is valid, then the user is considered to have been authenticated and is granted access to the relevant system (step 90).

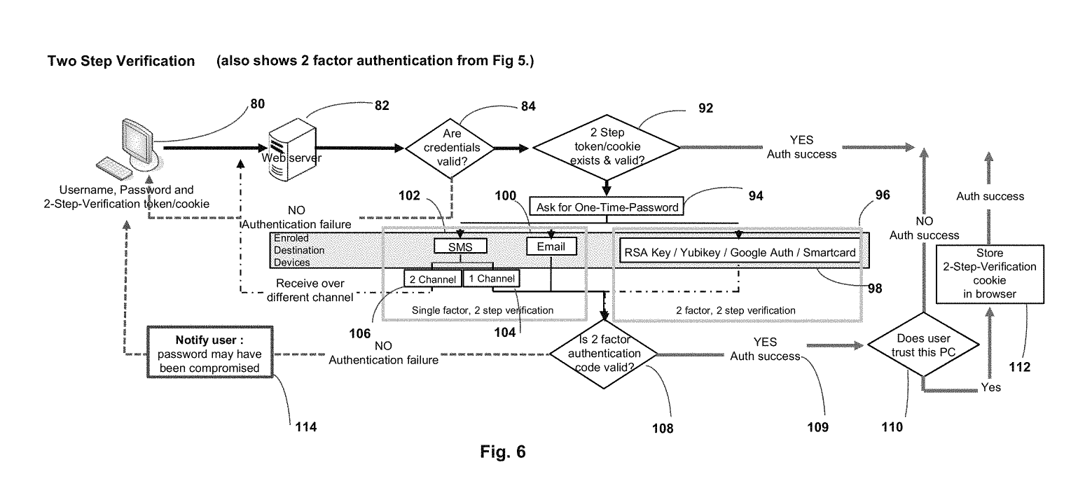

FIG. 6 is a diagram illustrating the process flow of a two-step authentication method (in contrast to a two-factor authentication method). As used herein, a two-step authentication scheme requires two physical keys, or two passwords, or two forms of biometric identification. In the case of multi-step (but not multi-factor) authentication, the attacker needs to perform one type of theft but multiple times (e.g., to use the key-logger to steal the password and the answer to a security question). It is not generally as strong as two-factor authentication, but is stronger than the single step process.

As described above, a user seeking to log in to the system is first asked to provide their username and password (step 80). If these credentials are valid, as part of a two-step authentication process, the electronic device from which the user is attempting to log into the system from is checked for the presence of a valid token/cookie (step 92). If the appropriate token/cookie is present, then the user is considered to have been authenticated and is granted access to the system. However, if the token/cookie is not present (e.g. the user is logging in from a new, non-enrolled device), then the two-step multi-factor authentication process (as previously described) may be used. The user is asked for a one-time password or security code (step 94), which may be sent to the user's enrolled destination device (step 96). The one-time password or security code may take various forms as illustrated in the specific example. The one-time password or security code may be in the form of a RSA SecurID token key, YubiKey™, Google Authenticator™ application or smartcard (step 98). Alternatively, it may be in the form of an email message (step 100). A further option is to use SMS text messaging (step 102). As shown in the example, the SMS may be 1 channel (step 104) or 2 channel (step 106). 2 channel SMS means that the one-time password data travels over an entirely independent network, not from the electronic device upon which user is trying to authenticate; in this case, eavesdropping is much harder for an attacker.

If the one-time password (also referred to in FIG. 6 as the 2nd factor authentication code) provided by the user is not valid, the authentication fails and, optionally, the user may be notified that the password may have been compromised (step 114). If the one-time password is valid, then the user can be considered to have been authenticated (step 109) and can be granted access to the relevant system. In the particular example shown, the user may optionally be asked whether the present device they are logging on from is a “trusted device” (step 110). For example, the device may be a public computer or belong to someone else. If the present electronic device is a trusted device, an appropriate token/cookie for future 2-step verification purposes can be stored in the trusted device's browser (step 112). If the device is not a trusted device, a token/cookie is not added, but the user is nevertheless considered authenticated and can be granted access to the system.

It may be noted that in the case where a one-time password is sent by SMS, for present purposes, this should probably not be considered to be a second factor. Although the mobile phone at first glance appears to be “something you have”, in this case, the device itself is not the key to authenticating; rather, it is the one-time-password delivered to it that is key. For example, a SMS text message can be intercepted by some means and an attacker can perform the authentication despite not having the device. On the other hand, if the user is using the Google Authenticator application, the mobile phone is required because the code is calculated on it (locally) and in this case, this would be a true second factor.

The following are provided as examples of possible authentication measures, which are presented in order of increasing strength of security:

1. Authentication with just a password−1 Factor Authentication.

2. Password+SMS code−1 Factor, 2-step verification with a single channel (received SMS code is passed back for verification by re-typing the received SMS code in the browser).

3. Password+Microsoft request approval app on smartphone−1 Factor 2 step verification with 2 channels (the reply to the received SMS is required to be made using SMS)

4. Password+Google Authenticator on a smartphone−2 Factor Authentication

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the system 10, any component of or related to the system 10 (e.g., the learning platform 12, database 16, pre-processing 26), etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of authenticating electronic documents, the method comprising:
enabling a first signing entity to connect to a server system, the server system having an electronic document securely uploaded thereto for signing by one or more signing entities including the first signing entity;
authenticating the first signing entity with the server system using at least one authentication operation;
obtaining a first graphical representation of a physical signature for the first signing entity;
applying a hybrid signature to the electronic document to generate an electronically signed document, the hybrid signature comprising the graphical representation of the physical signature and a first cryptographic element associated with the first signing entity;
outputting the electronically signed document or a link thereto; and
storing the electronically signed document with the server system.

2. The method of claim 1, wherein authenticating the first signing entity with the server system comprises a single factor authentication process.

3. The method of claim 2, wherein the single factor authentication process comprises a two-step verification comprising obtaining a plurality of credentials from the first signing entity.

4. The method of claim 3, wherein the two-step verification comprises using multiple channels.

5. The method of claim 1, wherein authenticating the first signing entity with the server system comprises a multi-factor authentication process.

6. The method of claim 5, wherein the multi-factor authentication process comprises:
obtaining a username and password as a first factor; and
obtaining a one-time password as a second factor.

7. The method of claim 6, further comprising sending the one-time password to an enrolled electronic device for the first signing entity, and requesting entry of the one-time password received by the enrolled device.

8. The method of claim 7, wherein the one-time password is generated on the enrolled device by an authenticator application.

9. The method of claim 5, wherein the multi-factor authentication process comprises a two-step verification comprising obtaining a plurality of credentials from the first signing entity.

10. The method of claim 1, wherein capturing the first graphical representation comprises obtaining the first graphical representation using an enrolled device being used by the first signing entity and being connected to the server system.

11. The method of claim 10, further comprising receiving the first graphical representation via a user interface action applied to the enrolled device.

12. The method of claim 11, wherein capturing the first graphical representation comprises obtaining the first graphical representation using a device not yet enrolled with the server system, the method further comprising accepting entry of a security code sent to the not yet enrolled device.

13. The method of claim 1, wherein the first signing entity is a new user, and wherein authenticating the first signing entity comprises sending a message to an electronic device for the new user to initiate the at least one authentication operation.

14. The method of claim 1, wherein the electronically signed document is a partially signed document, the method further comprising enabling at least one other signing entity to sign the electronically signed document by connecting to the server system.

15. The method of claim 14, further comprising enabling a second signing entity to connect to the server system;
authenticating the second signing entity with the server system using the at least one authentication operation;
capturing a second graphical representation of a physical signature for the second signing entity; and
incorporating the second graphical representation and a second cryptographic element associated with the second signing entity into the hybrid signature applied to the electronic document.

16. The method of claim 15, further comprising outputting a twice signed electronically signed document or a link thereto, and storing the twice signed electronically signed document with the server system.

17. The method of claim 1, wherein applying the hybrid signature to the electronic document comprises:
creating the first cryptographic element;
storing the first cryptographic element in a database;
creating a digest of the first graphical representation signature data;
signing the digest using the first cryptographic element; and
storing the signature data and the signed digest in the database.

18. The method of claim 1, wherein the first cryptographic element comprises a digital certificate.

19. The method of claim 18, wherein the digital certificate is an X509 certificate compatible with a portable document format (PDF) used to store the electronically signed document.

20. The method of claim 1, further comprising securely storing the electronically signed document with the server system with metadata for organizing electronically signed documents within the system.

21. The method of claim 1, wherein the first graphical representation is captured and stored by the server system prior to authenticating the first signing entity.

22. A computer readable medium comprising computer executable instructions for authenticating electronic documents, comprising instructions for:
enabling a first signing entity to connect to a server system, the server system having an electronic document securely uploaded thereto for signing by one or more signing entities including the first signing entity;
authenticating the first signing entity with the server system using at least one authentication operation;
obtaining a first graphical representation of a physical signature for the first signing entity;
applying a hybrid signature to the electronic document to generate an electronically signed document, the hybrid signature comprising the graphical representation of the physical signature and a first cryptographic element associated with the first signing entity;
outputting the electronically signed document or a link thereto; and
storing the electronically signed document with the server system.

23. A server system comprising a processor, a communication connection for connecting thereto, and memory, the memory comprising computer executable instructions for authenticating electronic documents, comprising instructions for:
enabling a first signing entity to connect to the server system, the server system having an electronic document securely uploaded thereto for signing by one or more signing entities including the first signing entity;
authenticating the first signing entity with the server system using at least one authentication operation;
obtaining a first graphical representation of a physical signature for the first signing entity;
applying a hybrid signature to the electronic document to generate an electronically signed document, the hybrid signature comprising the graphical representation of the physical signature and a first cryptographic element associated with the first signing entity;
outputting the electronically signed document or a link thereto; and
storing the electronically signed document with the server system.
